(19) United States
(12) Patent Application Publication
(10) Pub. No.: US 2022/0115910 A1
(43) Pub. Date: Apr. 14, 2022

(54) POWER TRANSMISSION AND RECEPTION SYSTEM, POWER RECEPTION DEVICE, AND POWER TRANSMISSION DEVICE

(71) Applicant: Hitachi-LG Data Storage, Inc., Tokyo (JP)

(72) Inventors: Kozo MASUDA, Tokyo (JP); Katsuhiko IZUMI, Tokyo (JP)

(21) Appl. No.: 17/475,639

(22) Filed: Sep. 15, 2021

(30) Foreign Application Priority Data
Oct. 8, 2020 (JP) 2020-170609

(51) Int. Cl. H02J 50/12; H04B 5/00

(52) U.S. Cl. CPC H02J 50/12; H04B 5/0037; H04B 5/0081

(57) ABSTRACT

A power transmission and reception system device includes: a first device including an outer surface on which a first image is represented; and a second device including an outer surface on which a second image is represented, the second device being placed on the first device. One of the first device and the second device is a power transmission device including a power transmission unit, and the other is a power reception device including a power reception unit. In a case where the power transmission device and the power reception device are positioned such that the first image and the second image are aligned, power can be fed such that a received voltage is greater than or equal to a predetermined value at the time of transmitting power to the power reception unit from the power transmission unit.

### CROSS-REFERENCE TO RELATED APPLICATION

The present application claims priority from Japanese application JP 2020-170609, filed on Oct. 8, 2020, the contents of which is hereby incorporated by reference into this application.

### BACKGROUND OF THE INVENTION

### 1. Field of the Invention

The present disclose relates to a power transmission and reception system, a power reception device, and a power transmission device.

### 2. Description of the Related Art

Recently, for example, in a small mobile electronic device such as a mobile terminal, a gaming console, a watch, an electric toothbrush, and an electric razor, a model using a wireless power transmission scheme in which a secondary battery or a capacitor that is built in the devices described above is charged in a non-contact manner without using a charging terminal has increased.

Further, even in a large device such as a hybrid car or an electric vehicle, a device in which charging is performed in a wireless manner has been developed.

In a wireless type power transmission system, for example, a technology described in JP 2011-244624 A has been known.

Recently, in accordance with the spread of a mobile terminal such as a smart phone and a tablet, a demand for charging such devices has increased. For this reason, power feeding or a charger is provided or built in a public area such as the vicinity of seats of various means of transportation (for example, an electric train, a bus, an aircraft, and the like) or tables of various vehicles, and the furniture (a desk and the like) in a store such that the electronic device can be charged in various areas. Currently, a wired system such as an AC plug or a USB power source is mainly used in such a public charging facility, but in the future, it is predicted or expected that a wireless type charging facility will also increase in accordance with the development of a wireless power transmission system.

On the other hand, in the wireless (in particular, a widely distributed electromagnetic guidance type) power transmission system, it is a critical issue to accurately position a power transmission unit (a power transmission coil) of a power transmission device and a power reception unit (a power reception coil) of a power reception device at the time of transmitting power. This is because in a case where such positioning is not accurate, it is not possible to sufficiently ensure a power transmission efficiency, and for example, a problem such as insufficient charging of a secondary battery on a power reception side may occur.

In this respect, in JP 2011-244624 A, a configuration is described in which the position of the power reception coil provided in the power reception device is detected on the power transmission device side, the size and the direction of a shift in the power reception coil are determined on the basis of a detection result, and a shift amount and a direction according to a determination result are displayed on a display unit by an arrow.

However, in the technology described in JP 2011-244624 A, it is necessary to provide a plurality of coils for detecting the current position of the power reception coil, and the like, and thus, there is a problem that the cost of the power transmission device or the entire system increases.

### SUMMARY OF THE INVENTION

An object of the one embodiment is to provide a power transmission and reception system, a power reception device, and a power transmission device that are capable of ensuring a power feeding efficiency while having a low-cost configuration.

One aspect of the one embodiment is a power transmission and reception system, including: a first device including an outer surface on which a first image is represented; and a second device including an outer surface on which a second image is represented, the second device being placed on the first device, in which one of the first device and the second device is a power transmission device including a power transmission unit, the other of the first device and the second device is a power reception device including a power reception unit, and when the power transmission device and the power reception device are positioned such that the first image and the second image are aligned, power is capable of being fed such that a received voltage is greater than or equal to a predetermined value at the time of transmitting power to the power reception unit from the power transmission unit.

Another aspect of the one embodiment is a power reception device, including: a power reception unit capable of being close to a power transmission unit of a power transmission device; and a display unit displaying a second image corresponding to a first image that is represented on the power transmission device, in which when the first image and the second image are positioned, power is capable of being received such that a received voltage is greater than or equal to a predetermined value at the time of transmitting power to the power reception unit from the power transmission unit.

Further, another aspect of the one embodiment is a power transmission device, including: a housing on which a first image corresponding to a second image that is displayed on a power reception device is represented; and a power transmission unit capable of being close to a power reception unit of the power reception device, the power transmission unit being contained in the housing, in which when the first image and the second image are positioned, the first image is represented at a position of the housing at which a received voltage in the power reception unit is greater than or equal to a predetermined value.

According to the one embodiment, a power transmission device and a power reception device are positioned through the positioning of a first image and a second image, and power can be fed such that a received voltage is greater than or equal to a predetermined value at the time of transmitting power to a power reception unit from a power transmission unit, and thus, a configuration for detecting the position of a power reception coil is not required. Therefore, according to the one embodiment, it is possible to ensure a power feeding efficiency while having a low-cost configuration.

### BRIEF DESCRIPTION OF THE DRAWINGS

FIG. 1 is a plan view describing an outline of a wireless power transmission system to which the one embodiment is applied;

FIG. 2 is a diagram describing a configuration and an operation of a power transmission device according to a first embodiment;

FIG. 3 is a block diagram illustrating a configuration example of a mobile terminal (a smart phone) on a power reception device side according to the first embodiment;

FIG. 4A is a plan view schematically illustrating a disposition example of a power reception coil or the like of the mobile terminal on the power reception device side;

FIG. 4B is a side view schematically illustrating a disposition example of the power reception coil or the like of the mobile terminal on the power reception device side;

FIG. 5A is a side view exemplifying a case where there is a shift in the position of a power transmission coil and the power reception coil;

FIG. 5B is a graph representing a relationship between a positional shift amount and received power (a decrease in a power feeding efficiency) between the power transmission coil and the power reception coil;

FIG. 6A is a plan view describing a state of the power transmission device before power transmission is started;

FIG. 6B is a plan view describing a screen that is displayed on the mobile terminal in a charging mode;

FIG. 6C is a plan view describing a state in which positioning of a first image and a second image is completed;

FIG. 7A is a plan view illustrating a main menu screen of the mobile terminal;

FIG. 7B is a plan view illustrating a display screen that can be switched after a “CHARGING” button (a charging icon) on the screen of FIG. 7A is tapped;

FIG. 7C is a plan view illustrating a display screen of the second image that can be switched after a “DISPLAY CENTER OF POWER RECEPTION COIL” button on the screen of FIG. 7B is tapped;

FIG. 8 is a flowchart describing processing that is performed by a main control unit of the mobile terminal;

FIG. 9 is a block diagram describing a configuration of a second embodiment of the wireless power transmission system;

FIG. 10A is a plan view illustrating a top menu screen of a mobile terminal in the second embodiment;

FIG. 10B is a plan view illustrating a display screen of a second image immediately after a charging mode is started in a case where a “CHARGING” icon on the screen of FIG. 10A is tapped;

FIG. 10C is a plan view illustrating a main menu screen in charging processing after an “OK” button on the screen of FIG. 10B is tapped;

FIG. 10D is a plan view illustrating a display screen of the second image in a case where there is a positional shift after the charging processing is started;

FIG. 11 is a flowchart illustrating processing that is executed by a main control unit of the mobile terminal of the second embodiment;

FIG. 12 is a table for describing another example of the first image and the second image;

FIG. 13A is a plan view illustrating another display mode of a center position of the power reception coil;

FIG. 13B is a plan view illustrating another display mode of the center position of the power reception coil;

FIG. 13C is a plan view illustrating another display mode of the center position of the power reception coil;

FIG. 13D is a plan view illustrating another display mode of the center position of the power reception coil; and

FIG. 14 is a table for describing still another example of the first image and the second image.

### DETAILED DESCRIPTION OF THE PREFERRED EMBODIMENTS

Embodiments to which the one embodiment is applied will be described in detail with reference to the drawings.

In the configurations of the embodiments described below, the same reference numerals will be used in common by the same parts or parts having the same function in different drawings, and the repeated description thereof may be omitted.

### First Embodiment

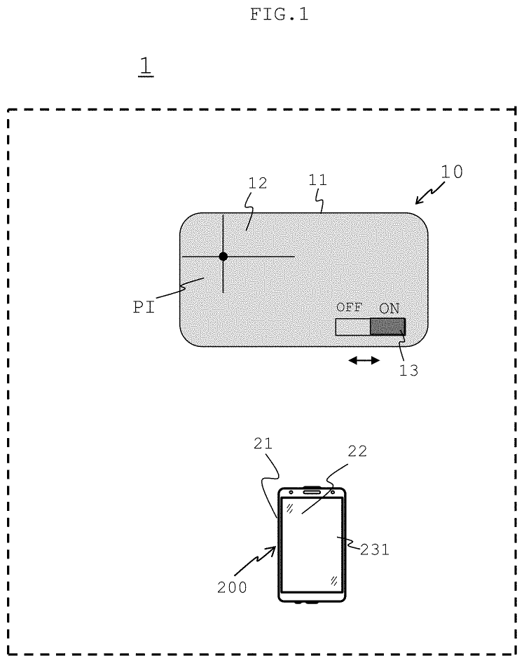

FIG. 1 is a plan view for describing the outline of a wireless power transmission system (hereinafter, simply referred to as a power transmission system) of an embodiment of the one embodiment.

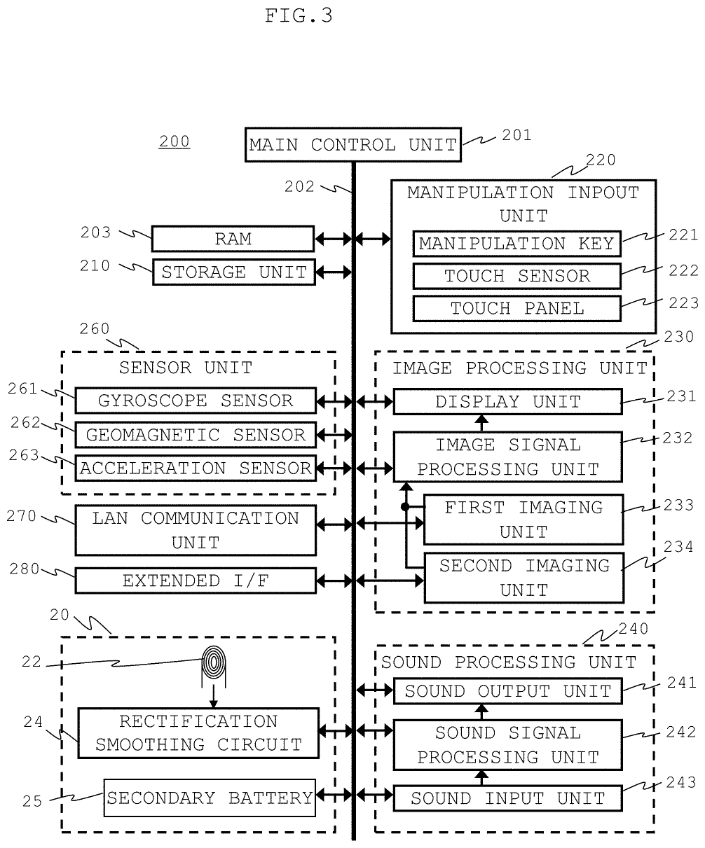

Such a power transmission system 1 includes a power transmission device 10 including a power transmission coil (a power transmission unit) that transmits power (a high-frequency current) in a wireless manner or in a non-contact manner, and a mobile terminal 200 in which a power reception device 20 (refer to FIG. 3) including a power reception coil (a power reception unit) that receives the power transmitted from the power transmission device 10 is built. In this example, the power transmission device 10 corresponds to a “power transmission device” and a “first device” of the one embodiment, and the power reception device 20 and the mobile terminal 200 correspond to a “power reception device” and a “second device” of the one embodiment.

In this example, the power transmission device 10 is a stationary device using a versatile power source of AC 100 to 120 V. The power transmission device 10 can be used in various areas such as being placed on a desk or a table or being fixedly used by being embedded in a concave portion on the upper surface of the furniture.

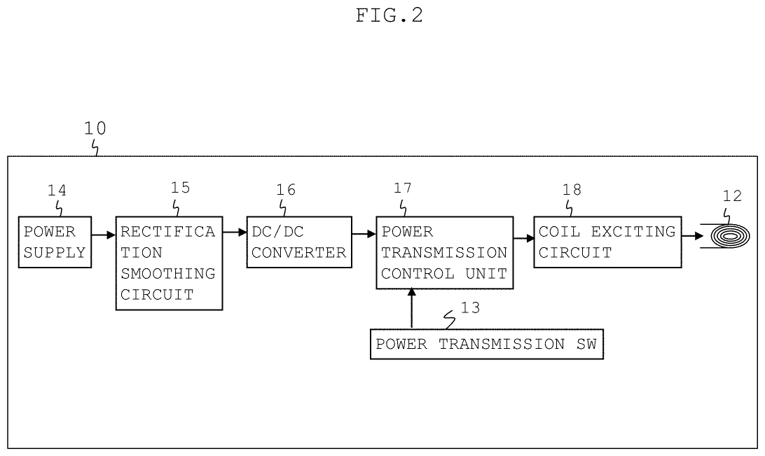

In the power transmission device 10, a power transmission coil 12 configuring a main part of the power transmission unit is disposed in a housing 11 (refer to FIG. 2). In this example, the power transmission coil 12 is disposed on the left top corner side of the housing 11, in the plan view based on a horizontal direction illustrated in FIG. 1. In this example, the power transmission coil 12 is disposed such that a radial direction of the power transmission coil 12 is approximately parallel to the upper surface of the housing 11. In addition, the upper surface of the housing 11 is a surface on which the mobile terminal 200 is placed and is horizontal to the floor surface.

Note that, as necessary, another power transmission coil 12 can also be additionally disposed on the other end portion side in the housing 11 (in this example, the right top corner side or the left bottom corner side in FIG. 1). Here, in order to avoid complicating the description, here, the description will be made on the premise of a case where one power transmission coil 12 (power transmission unit) is disposed in the housing 11.

A power transmission switch 13 switching the on/off (ON/OFF) of power transmission (charging) is disposed on the upper surface of the housing 11 of the power transmission device 10. The power transmission switch 13 is a sliding type manual switch (refer to a double-headed arrow in FIG. 1), and in a state illustrated in FIG. 1, the power transmission switch 13 is in an ON state. In the power transmission switch 13, for example, any other type of switch such as a push type switch can be used.

In this embodiment, a print image PI approximately in a “cross” shape having a position facing the center of the power transmission coil 12 on the upper surface of the housing 11 as a reference point (a intersection position) is formed. Such a print image PI corresponds to a “first image” of the one embodiment, and the meaning thereof will be described below.

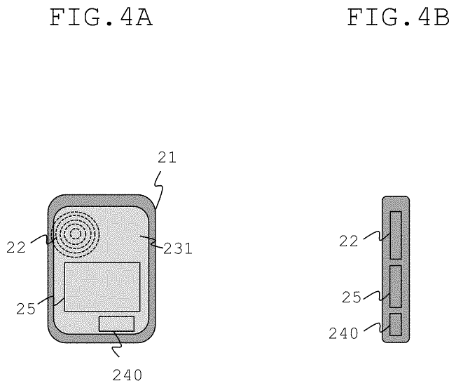

The bottom surface of the power reception device 20 is placed (positioned) on the surface (in this example, the upper surface) of the housing 11, and power is fed (transmitted) to the power reception coil 22 described below in the placed power reception device 20, and thus, the power transmission device 10 functions as a charger charging a secondary battery 25 (refer to FIG. 3 and FIGS. 4A and 4B).

On the other hand, in this example, the power reception device 20 is built in a mobile terminal device (hereinafter, referred to as the mobile terminal) 200 that is generally referred to as a smart phone, and a power reception coil 22 configuring the power reception unit is disposed in a housing of such a mobile terminal 200 (refer to FIG. 3 and the like). On the other hand, a touch panel type display unit 231 having both of a manipulation input function and an image display function is provided on the upper surface of the housing 21.

FIG. 2 is a schematic block diagram for describing the internal configuration of the power transmission device 10 of a first embodiment of the power transmission system 1, the flow of a signal, and the like.

A power supply unit 14, a rectification smoothing circuit 15, a DC/DC converter 16, a power transmission control unit 17, and a coil exciting circuit 18 are provided in the housing 11 of the power transmission device 10, in addition to the power transmission coil 12 and the power transmission switch (in FIG. 2, a “power transmission SW”) 13 described above.

The power supply unit 14, for example, includes a power cable inputting an alternating current (in this example, 50 Hz, 100 V) from a power plug, a switch IC for switching the on/off of power supply, and the like, and feeds the alternating current that is transmitted through the power cable to the rectification smoothing circuit 15.

The rectification smoothing circuit 15, for example, is a circuit using a semiconductor diode and a capacitor, converts the input alternating current into a direct current having a constant voltage by performing rectification (DC electrification) and smoothing processing of an alternating waveform, and feeds the power after being converted to the DC/DC converter 16.

The DC/DC converter 16 converts (steps down) the voltage of the input direct current into a voltage that is necessary to excite the power transmission coil 12, and feeds the power after being stepped down to the power transmission control unit 17.

The power transmission control unit 17 feeds the direct current that is input from the DC/DC converter 16 to the coil exciting circuit 18 or stops the power feeding, in accordance with the state (ON or OFF) of the power transmission switch 13.

In order to excite the power transmission coil 12, the coil exciting circuit 18 includes an inverter circuit converting a direct current to an alternating current. The coil exciting circuit 18 converts the direct current that is fed from the power transmission control unit 17 to an alternating current having predetermined voltage and frequency, and outputs such an alternating current to the power transmission coil 12. The power transmission coil 12, for example, is a spiral type circular coil in which an electric wire such as an enamel insulated wire is wound approximately into the shape of a ring in the plan view.

FIG. 3 is a block diagram illustrating the configuration of a control system of the mobile terminal 200 in which the power reception device 20 is built.

As illustrated in FIG. 3, the mobile terminal 200 includes the power reception device 20, a main control unit 201, a RAM 203, a storage unit 210, a manipulation input unit 220, an image processing unit 230, a sound processing unit 240, a sensor unit 260, a LAN communication unit 270, an extended interface 280, and the like, in the housing 21. The units (hereinafter, also referred to as “operation blocks”) are electrically connected to each other through a system bus 202.

Note that, in many smart phones, a position information acquisition unit using a GPS and a sensor unit such as an acceleration sensor are further provided, but such units are known and have less relativeness with the characteristics of this embodiment, and thus, the illustration and the description thereof will be omitted.

Among the above units, the main control unit 201 includes a processor such as a CPU or a MPU, a ROM, and a basic program or the like stored in the ROM, and each of the operation blocks is controlled by the processor executing the basic program or the like, and thus, the main control unit 201 comprehensively controls the entire mobile terminal 200.

In addition, the main control unit 201 functions as a display control unit controlling the display and the non-display of the second image described below.

The system bus 202 is a data communication path between the main control unit 201 and each of the operation block in the mobile terminal 200. The RAM 203 is a work area at the time of executing an operation program.

The storage unit 210 stores individual operation programs, operation setting values, or the like of the mobile terminal 200. In this embodiment, in the storage unit 210, data such as an operation program or an operation setting value relevant to the second image described below is stored. Such data, for example, can be acquired from a predetermined server as an application.

The power reception device 20 includes the power reception coil 22, a rectification smoothing unit 24, and the secondary battery 25. The power reception coil 22 is a spiral type circular coil having the same configuration as that of the power transmission coil 12 described above. In addition, the power reception coil 22 is disposed such that a radial direction of the coil is approximately parallel to the lower surface of the housing 21.

Note that, as the power transmission coil 12 and the power reception coil 22, coils having various structures or types such as a spiral type coil approximately in a polygonal shape in the plan view, a combination of a plurality of rectangular spiral coils, or a solenoid type coil can also be used. In addition, the number of winds of the electric wire configuring the coil, whether a single-wire or a double-wire (a litz wire or the like), and the like are also arbitrary.

The rectification smoothing unit 24, for example, is a circuit including a diode or a capacitor, and generates a direct current having a stable voltage by rectifying (pulsating) and smoothing an induced current (an alternating current) that is generated in the power reception coil 22. The secondary battery 25 is a battery capable of performing repeated charging and discharging, and for example, is a lithium-ion battery.

The manipulation input unit 220 is a user manipulation interface receiving manipulation input of a user with respect to the mobile terminal 200. Specifically, the manipulation input unit 220 includes a manipulation key 221 such as a power source key, a volume key, and a home key, a touch sensor (a touch pad) 222, and a touch panel 223. Among them, the touch panel 223 is integrally disposed by being superimposed on the display unit 231, and is also referred to as a touch screen.

The image processing unit 230 includes the display unit 231 described above, an image signal processing unit 232, a first imaging unit 233, and a second imaging unit 234.

The first imaging unit 233 is an out-camera (a rear camera), and is used in a case of imaging the background or the like on the rear side of the housing 21. The second imaging unit 234 is an in-camera (a front camera), and is used in a case of imaging the background or the like on the front side of the housing 21 or performing face authentication of the user. Such imaging units 233 and 234, for example, are a camera including a CCD imaging element, convert light that is received at the time of imaging into an electric signal by the imaging element, and feed the converted electric signal (an analog signal) to the image signal processing unit 232.

The image signal processing unit 232 generates digital image data by performing A/D conversion with respect to the electric signal fed from the imaging units 233 and 234, and drives the display unit 231 to display the generated image data. In addition, the image signal processing unit 232 drives the display unit 231 to display image data (an object) that is read out from a memory (the RAM 203, the storage unit 210, or the like) by the main control unit 201. The display unit 231 displays the image data input from the image signal processing unit 232 in a display screen.

The sound processing unit 240 includes a sound output unit 241, a sound signal processing unit 242, and a sound input unit 243. The sound output unit 241 is a speaker, and outputs a sound that is processed by the sound signal processing unit 242. The sound input unit 243 is a microphone, and inputs the voice of the user, or the like.

The LAN communication unit 270 is connected to a network by a wireless communication method, and performs transmission and reception of data with respect to a management server on the network.

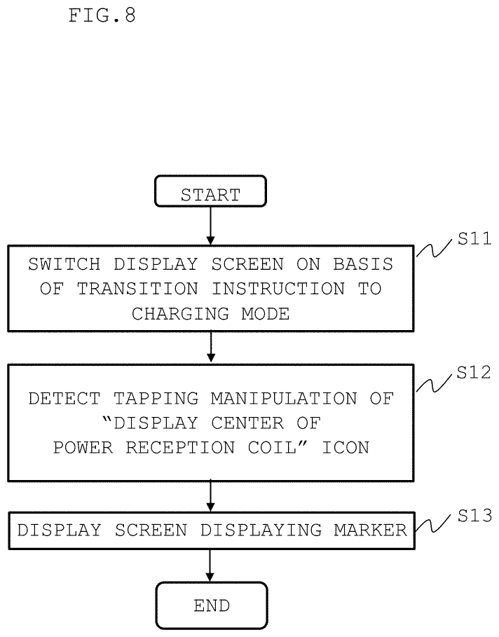

Note that, the LAN communication unit 270 is capable of performing near field communication using a near field communication antenna 271 (refer to FIG. 8) such as Bluetooth (Registered Trademark), and such a respect will be described below.

The extended interface (I/F) 280 is an interface group for extending the function of the mobile terminal 200.

FIG. 4A and FIG. 4B are a plan view and a side view schematically illustrating a disposition example of the power reception coil 22, the secondary battery 25, and the sound processing unit 240 that are stored in the housing 21 of the mobile terminal 200 (the smart phone). Note that, in practice, the antenna 271 (refer to FIG. 8) of the LAN communication unit 270 illustrated in FIG. 3 is also disposed in a block of a reference numeral 240.

As illustrated in FIG. 4A and FIG. 4B, the power reception coil 22 and the secondary battery 25 are disposed not to overlap with each other, and thus, the housing 21 can be thinned. In addition, the sound processing unit 240 or the antenna 271 described above is disposed by being separated from the power reception coil 22, and thus, the influence of a magnetic field that is generated in the power reception coil at the time of charging the secondary battery 25 on communication quality can be minimized.

The user places the housing 21 on the power transmission device 10 such that the rear surface (the lower surface) of the housing 21 faces the upper surface of the housing 11 of the power transmission device 10 and turns the power transmission switch 13 of the power transmission device 10 ON in a case of charging the secondary battery 25 of the mobile terminal 200. At this time, alternating-current magnetic flux is generated by a current of a high-frequency wave (for example, approximately 60 to 600 kHz) flowing to the power transmission coil 12, and an alternating-current voltage is induced in the facing power reception coil 22 by an electromagnetic dielectric action similar to the transformer principle. The induced alternating-current voltage is converted into a direct current by the rectification smoothing unit 24, and then, is fed to the secondary battery 25.

According to such a wireless power feeding method, a junction portion is not exposed by a terminal, and thus, it is easy to ensure waterproof properties, and charging can be performed without using a cable, and thus, it is possible to obtain various advantages such as being able to perform charging in different models, compared to a wired power feeding method using connector connection of the related art.

However, in such a wireless power feeding method, in particular, in the electromagnetic guidance type power transmission system 1, in order to ensure a power feeding efficiency at the time of power transmission, it is necessary to position the coils 12 and 22 as accurate as possible. In a case where such positioning is not accurate, it is not possible to sufficiently ensure the efficiency of the power transmission or the power feeding (the charging), and for example, there may be a problem such as insufficient charging of the secondary battery 25.

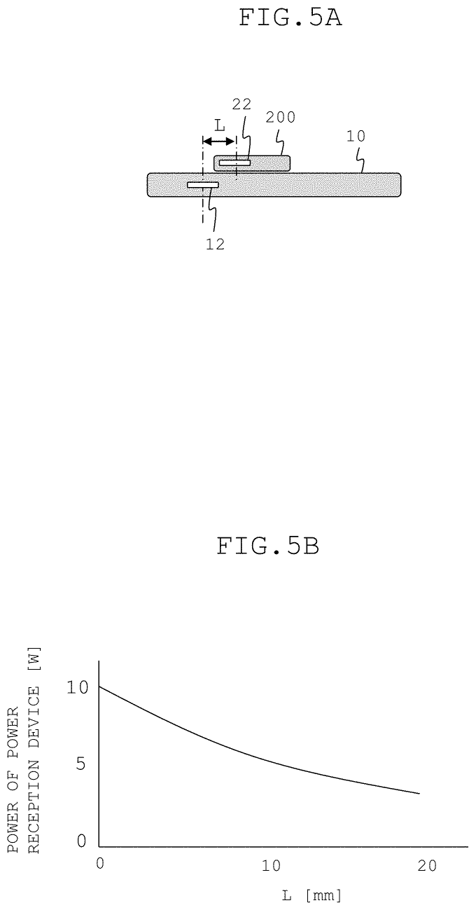

Here, with reference to a side view of FIG. 5A and a characteristic graph of FIG. 5B, it is found that the amount of power that can be received by the power reception device 20 decreases as a shift amount L between the center point of the power transmission coil 12 and the center point of the power reception coil 22 increases. That is, with reference to FIG. 5B, it is found that even in a case where the positional shift amount L between both of the coils 12 and 22 is approximately several mm, the power feeding efficiency greatly decreases, and in a case where the positional shift amount L is approximately 10 mm, power (W) to be received decreases to a half or less, compared to a case where there is no positional shift.

Accordingly, in a case where accurate positioning is not performed between both of the coils 12 and 22, the secondary battery 25 in the mobile terminal 200 is not sufficiently charged, and there can be various problems such as taking great deal of time to be fully charged or suspecting the failure or the life-span of the secondary battery 25 due to not being fully charged at all.

Note that, the configuration example described above is premised on a case where the areas of the facing surfaces of two devices, that is, the area of the upper surface of the power reception device 20 and the area of the rear surface (the lower surface) of the mobile terminal 200 are different from each other (the former is large and the latter is small), but the problem of the positional shift in the coil described above is capable of occurring regardless of the size of the area of the facing surfaces.

In the related art, from the viewpoint of preventing or suppressing a decrease in the power feeding efficiency associated with the positional shift in the coil, a configuration is proposed in which relative positions of two coils on a plane are determined, and in accordance with such a determination result, a direction and a distance in which the user is to move the mobile terminal 200 are displayed by a dynamic arrow.

In such a configuration, the position of the power reception coil 22 provided in the mobile terminal 200 is detected on the power transmission device 10 side, and the current position (a direction with respect to a predetermined position, or the like) of the power reception coil 22 is displayed on the basis of a detection result. According to such a configuration, a shift amount of the power reception coil 22 or the direction in which the mobile terminal 200 is to be moved is displayed on the display unit 231 by an image of an arrow, in accordance with the current position of the power reception coil 22 in the mobile terminal 200 (a positional relationship with respect to the power transmission device 10), and display is performed in which the direction or the length of the arrow is dynamically changed.

However, in such a configuration of the related art, it is necessary to provide a configuration for detecting the current position of the power reception coil 22, for example, a plurality of coils or the like different from the power transmission coil 12 on the power transmission device 10 side, and thus, there is a problem that the cost of the power transmission device 10 and the entire system increases.

The present inventors have devised the following configuration in consideration of the problems as described above and the fact that the power transmission coil and the power reception coil that are used in the current wireless power transmission system are generally in the shape of a circle in the plan view.

In this embodiment, in order to accurately align a position between the power transmission unit and the power reception unit (the power transmission coil 12 and the power reception coil 22), the first image and the second image are provided on the outer surface of the housing 11 of the power transmission device 10 and the outer surface of the housing 21 of the mobile terminal 200, as a so-called reference index, respectively. Here, in a case where the power transmission device 10 and the mobile terminal 200 (in which the power reception device 20 is built) are positioned such that the first image and the second image are aligned, the first image and the second image are disposed such that the power can be fed such that a received voltage is greater than or equal to a predetermined value at the time of transmitting power to the power reception coil 22 (the power reception unit) from the power transmission coil 12 (the power transmission unit).

In one specific example, the center position of the power transmission unit and the power reception unit (the power transmission coil 12 and the power reception coil 22) is set to a reference position at the time of positioning. In this case, when the power transmission device 10 and the mobile terminal 200 (in which the power reception device 20 is built) are positioned such that the first image and the second image are aligned, the center portions of the power transmission coil 12 (the power transmission unit) and the power reception coil 22 (the power reception unit) are aligned, and thus, the power feeding efficiency is ensured.

According to the configuration described above, it is sufficient that the positions of the respective indices (the first image and the second image) fixedly (statically) disposed on the outer surfaces of the respective devices are coincident with each other, and thus, a configuration for detecting the current position of the coil is not required, and a low cost can be attained.

Here, it is considered that the indices, that is, the first image and the second image are disposed on abutting surfaces of the respective devices (10 and 200) at the time of transmitting power. On the other hand, in a case where the indices are disposed on the abutting surfaces of the devices (10 and 200), there is a drawback from the viewpoint of workability such that the user is required to carefully observe the indices from the lateral surface side of each of the devices.

Therefore, in this embodiment, in order to facilitate the workability, the indices are provided on the upper surfaces of the respective devices, specifically, the abutting surface (the upper surface) of the housing 11 of the power transmission device 10, and a surface (the front surface or the upper surface) on a side opposite to the facing surface (the rear surface or the lower surface) of the housing 21 of the mobile terminal 200.

Here, an index indicating the center position of the power transmission coil 12 is provided on the upper surface of the housing 11 of the power transmission device 10 by printing or sealing the index (the first image), groove formation, or the like. Hereinafter, the description will be made on the premise of a case where the first image is printed on the upper surface housing 11 of the power transmission device 10.

On the other hand, the display unit 231 (the touch panel) is provided on the upper surface of the mobile terminal 200 in which the power reception device 20 is built (the front surface of the housing 21), as a manipulation display unit. Therefore, in this embodiment, an index indicating the center position of the power reception coil 22 (the second image) is fixedly displayed on the display unit 231, as a still image.

Here, the second image is an image that is necessary only at the time of charging and becomes rather annoying (irritating) at the time of using the mobile terminal 200, and thus, as described below, is displayed on the display unit 231, in accordance with the instruction of the user and the control of the main control unit 201, as necessary.

Note that, in the configuration on the power reception device side, a case where the display unit is not disposed on the outer surface of the housing on which the center position of the power reception coil 22 is to be displayed, a case where there is the display unit but the display unit is disposed at a position not corresponding to the center position of the power reception coil 22, and the like are also considered as another embodiment. A display example of the first image and the second image in such a case will be described below.

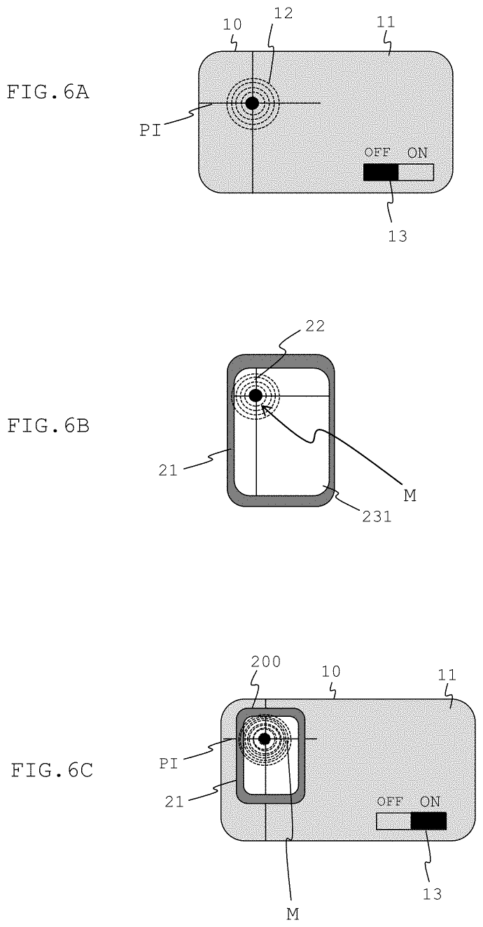

Hereinafter, one specific example of this embodiment and a positioning operation of the coils (12 and 22) that is performed by the user will be described with reference to schematic plan views of FIG. 6A to FIG. 6C. Note that, in order to facilitate the understanding, in FIG. 6A to FIG. 6C, the outer shapes (plan positions) of the power transmission coil 12 in the housing 11 and the power reception coil 22 in the housing 21 are illustrated by using dotted lines, respectively, but in practice, such lines (the shapes of the coils 12 and 22) are not printed or displayed. Here, the shapes of the coils 12 and 22 may be printed or displayed (in other words, the outer shape of the coil is also an element of the first image and the second image).

FIG. 6A is a diagram describing the state of the power transmission device 10 before the power transmission is started, and the power transmission switch 13 is in an OFF state (suitably refer to FIG. 1). Then, as illustrated in FIG. 6A, a reference index PI indicating the reference position (the center point) of the power transmission coil 12 is represented by printing on the upper surface of the housing 11 of the power transmission device 10, as the first image described above.

The reference index PI includes lines intersecting with each other (in this example, two straight lines orthogonal to each other) at the center position of the power transmission coil 12 in the housing 11, and a mark (in this example, a black circle) for clarifying or emphasizing the center position.

Hereinafter, for distinction, the description will be made by referring to the reference index PI applied to the power transmission device 10 as a “print image” PI.

FIG. 6B is a diagram describing a screen that is displayed on the display unit 231 of the mobile terminal 200 before the power transmission is started (when a charging mode described below is started). As illustrated in FIG. 6B, a reference index M indicating the reference position (the center point) of the power reception coil 22 is fixedly displayed on the display unit 231 on the upper surface side of the housing 21 of the mobile terminal 200, as the second image (the still image). Hereinafter, for distinction, the reference index M will be referred to as a “marker” M.

In this embodiment, the marker M as the second image has the same shape as that of the print image PI (the first image) described above. That is, the marker M includes lines intersecting with each other (in this example, two straight lines orthogonal to each other) at the center position of the power reception coil 22 in the housing 21 of the mobile terminal 200, and a mark (in this example, a black circle) for clarifying or emphasizing the center position.

Here, the housing 21 of the mobile terminal 200 is smaller than the housing 11 of the power transmission device 10, and thus, two straight lines (a vertical line and a horizontal line) configuring the marker M are comparatively shorter than those of the print image PI. On the other hand, it is considered to be desirable that the two straight lines (the vertical line and the horizontal line) configuring the marker M is as long as possible, from the viewpoint of the ease of positioning, and thus, in this example, the two straight lines are configured to extend to the lateral end side of the housing 21, in other words, are displayed to extend to the end side of a display region of the display unit 231.

In contrast, two straight lines (a vertical line and a horizontal line) configuring the print image PI (the first image) represented on the upper surface of the power transmission device 10 are comparatively longer than a vertical width and a horizontal width of the housing 21 of the mobile terminal 200. According to such a configuration, the first image and the second image are easily positioned (refer to FIG. 6C).

Further, in this example, among the two straight lines configuring the print image PI (the first image), both ends of the vertical line extend to the lateral edge of the housing 11, whereas only one end side (the left end side) of the horizontal line extends to the lateral edge of the housing 11 and the other end side (the right end side) extends to a necessary and sufficient extent (to the extent of being observed at the time of positioning).

According to the configuration as described above, it is possible to limit or restrict the direction in which the mobile terminal 200 is placed on the upper surface of the power transmission device 10. Specifically, in order to position each of four end portions of the vertical line and the horizontal line of the marker M (the second image), the mobile terminal 200 is to be placed in the direction illustrated in FIG. 6C, and in a case where the positioning is performed in other directions, it is possible to easily and immediately grasp that any one of the end portions is not capable of being positioned or protrudes from the upper surface of the power transmission device 10 (the mobile terminal 200 easily drops).

Accordingly, the user is capable of intuitively understanding the direction, the distance, or the like in which the positioning is to be performed by moving the mobile terminal 200 in a state where the marker M is displayed close to the power transmission device 10. Then, as illustrated in FIG. 6C, in a case where the position of the print image PI (the first image) and the position of the marker M (the second image) are coincident with each other, the positioning of the centers of the coils 12 and 22 is completed, and the received voltage (for example, an output voltage of the rectification smoothing unit 24) at the time of transmitting power to the power reception coil 22 from the power transmission coil 12 can be ensured to be greater than or equal to a predetermined value.

FIG. 6C illustrates a state in which the positioning of both of the devices 10 and 20 is completed and charging processing is started, and the switch 13 of the power transmission device 10 is in an ON state.

As described above, in the power transmission system 1 of this embodiment, it is possible to easily attain accurate positioning of both of the coils 12 and 22 and the ensuring of the power feeding efficiency while having a low-cost configuration, and to effectively prevent various problems such as insufficient charging due to the positional shift or the like.

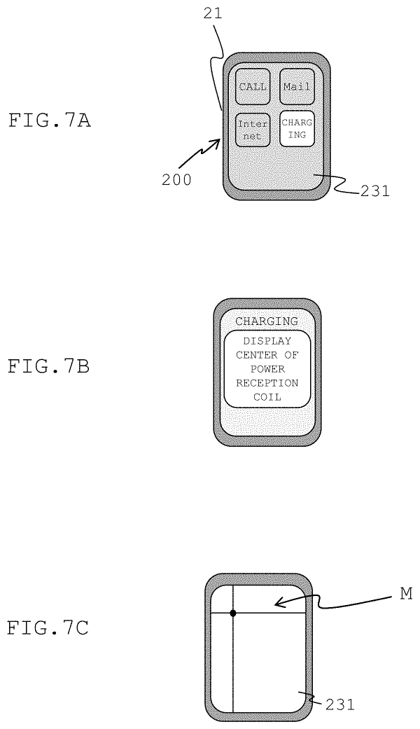

Next, a procedure of displaying the marker M (the second image) on the mobile terminal 200, or the like of will be described with reference to a transition example of the display screen of the display unit 231 illustrated in FIG. 7A to FIG. 7C and a flowchart of FIG. 8.

In this embodiment, the marker M as the second image described above is not displayed at normal times, but is displayed during the charging mode of the mobile terminal 200, in accordance with the instruction of the user and the control of the main control unit 201.

In one specific example, in a case where a “CHARGING” icon among four icons displayed on a top menu screen at normal times, illustrated in FIG. 7A, is tapped, the charging mode is started, and transition to a screen illustrated in FIG. 7B is performed. In the screen illustrated in FIG. 7B, in a case where a “DISPLAY CENTER OF POWER RECEPTION COIL” icon is tapped by the user, transition to a screen illustrated in FIG. 7C is performed, in accordance with the control of the main control unit 201, and the marker M described above is displayed.

FIG. 8 is a flowchart illustrating a procedure of processing in which the marker M (the second image) of the first embodiment is displayed.

In the display screen illustrated in FIG. 7A, in a case where a tapping manipulation of the “CHARGING” icon is performed by the user, the main control unit 201 of the mobile terminal 200 determines (detects) that it is a transition instruction to the charging mode, and controls the display unit 231 such that the display screen is switched to the screen illustrated in FIG. 7B (step S11).

Subsequently, the main control unit 201 waits until a “DISPLAY CENTER OF RECEPTION COIL” icon in the display screen is selected (tapped). Note that, at this time, the main control unit 201 may perform processing of additionally displaying a message for prompting the user to perform the tapping manipulation, such as “PLEASE TAP THIS ICON”, on the display screen.

Then, in a case where the main control unit 201 detects the selection (the tapping manipulation) of the “DISPLAY CENTER OF POWER RECEPTION COIL” icon during the display of the display screen illustrated in FIG. 7B (step S12), the main control unit 201 further controls the display unit 231 such that the display screen is switched to the screen (the display screen of the marker M) illustrated in FIG. 7C (step S13).

In an example of the processing of step S13, the main control unit 201 reads out an xy coordinate point of the display unit 231 corresponding to the center position of the power reception coil 22 from the memory, and controls the display unit 231 such that the center point (in this example, an intersection point of two straight lines and a black circle) of the marker M is disposed at such a center position (the xy coordinate point).

As a result thereof, as illustrated in FIG. 7C, the marker M as the second image is displayed on the entire display region of the display unit 231. Accordingly, the display unit 231 of this embodiment displays the marker M (the second image) such that an intersection point of two lines (a vertical line and a horizontal line) is at the facing position of the center point of the power reception coil 22. In other words, in a case where the positioning with the print image PI (the first image) is completed, the display unit 231 displays the marker M (the second image) at a position on the display screen of the display unit 231 at which the received voltage in the power reception coil 22 (the power reception unit) is greater than or equal to a predetermined value.

Note that, as described above in FIG. 6B, a shape such as the outline of the power reception coil 22 may be additionally applied as the marker M (for example, whether or not to display the shape of the power reception coil 22 can be selected by the manipulation of the user). It can be expected that the shape such as the outline of the power reception coil can be useful as a positioning indicator at the time of charging and offers a psychological sense of security, and thus, it may be configured that the shape of the power reception coil 22 can be displayed as an option by the selection of the user.

The print image PI and the marker M described above are an example, and other specific examples will be described below.

### Second Embodiment

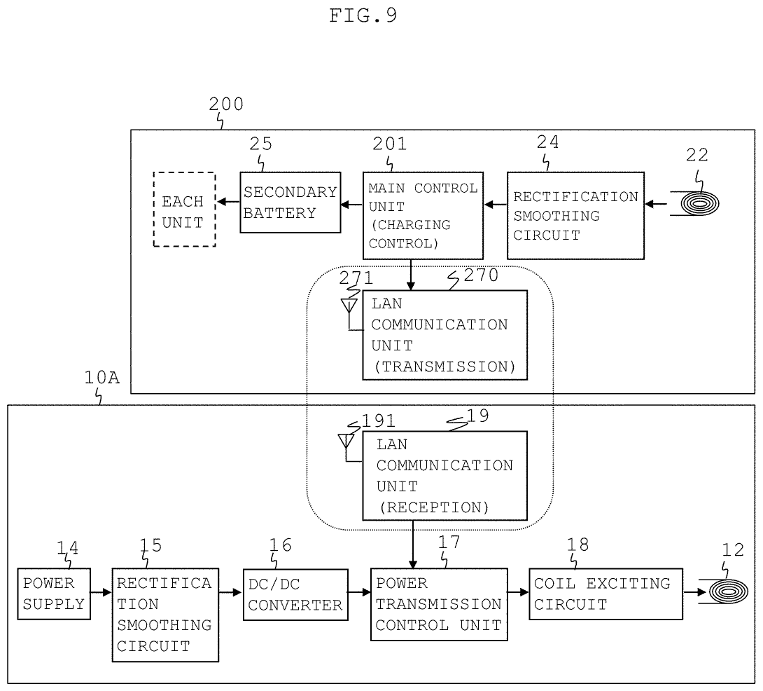

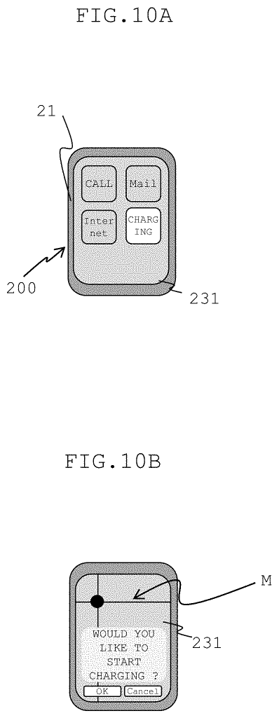

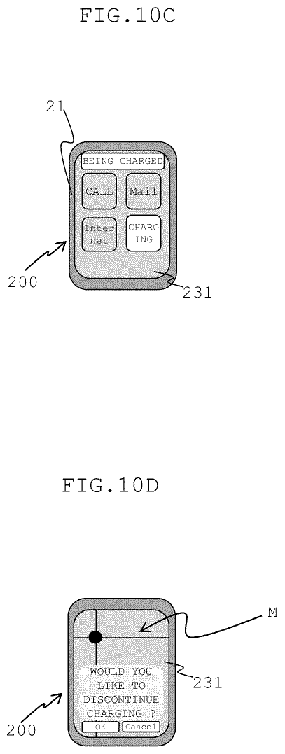

Next, a second embodiment of the wireless power transmission system will be described with reference to FIG. 9, FIG. 10, and the subsequent drawings. FIG. 9 is a schematic block diagram of a power transmission device 10A and a part of the mobile terminal 200 (mainly the power reception device 20) of the second embodiment. Note that, the other configuration of the mobile terminal 200 is the same as described above in FIG. 3, and thus, the detailed illustration and described will be omitted.

The power transmission device 10A illustrated in FIG. 9 includes a LAN communication unit 19 instead of the power transmission switch 13 (refer to FIG. 2) described above. The LAN communication unit 19 has the same configuration as that of the LAN communication unit 270 of the mobile terminal 200 described above, and performs near field communication with the LAN communication unit 270 of the mobile terminal 200 by using a near field communication antenna 191 such as Bluetooth (Registered Trademark).

In the wireless power transmission system of the second embodiment, an operation of switching the on/off of a power feeding operation is performed through the near field communication between the LAN communication unit 270 and the LAN communication unit 19 described above. For this reason, the main control unit 201 of the mobile terminal 200 outputs a power transmission start command and a power transmission discontinuance command to the power transmission control unit of the power transmission device 10, and functions as a “power transmission operation switching unit” switching the on/off of the power transmission by the power transmission device 10.

In addition, the main control unit 201 monitors a power transmission efficiency between the power transmission coil 12 and the power reception coil 22, determines whether or not the charging is suitably performed, on the basis of a monitoring result, and in a case where the charging is not suitably performed, performs display control of prompting the user to perform an operation such as positioning.

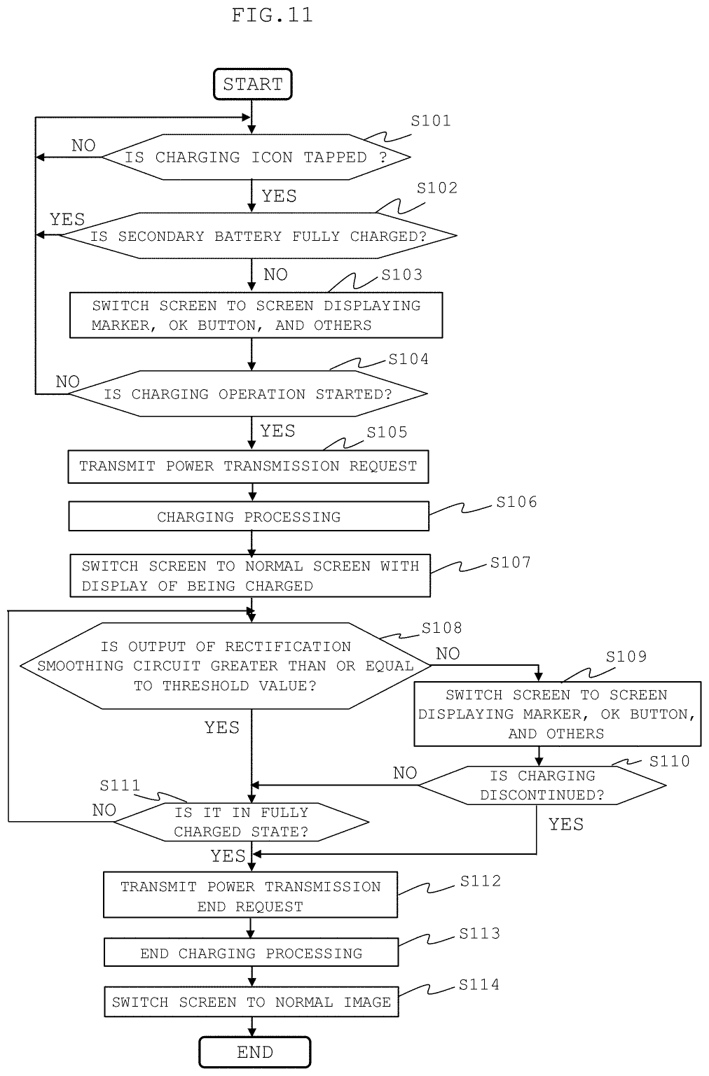

Hereinafter, the operation or the like of the mobile terminal 200 and the power transmission device 10 of the second embodiment will be described with reference to FIG. 10A to FIG. 10D and a flowchart of FIG. 11.

FIG. 10A is a diagram illustrating the same display screen as that of FIG. 7A described above. That is, in a case where the “CHARGING” icon is selected from the menu screen (for example, the top menu) described above by the tapping manipulation of the user, the main control unit 201 performs transition to the charging mode, and as illustrated in FIG. 10B, performs processing of displaying the marker M (the second image) as the reference for the position of the power reception coil 22 on the display unit 231.

Note that, FIG. 10B illustrates a display screen corresponding to that of FIG. 7C described above, but has the following difference. That is, in the example of FIG. 7C, only the marker M (the second image) is displayed on the display screen, whereas in a display screen illustrated in FIG. 10B, an “OK” button, a “Cancel” button, and a message of “WOULD YOU LIKE TO START CHARGING?” are additionally displayed on the screen of the touch panel.

This is because in the first embodiment, the on/off of the charging is performed on the power transmission device 10 side (the power transmission switch 13), whereas in the second embodiment, the main control unit 201 of the mobile terminal 200 mainly switches the on/off of the power transmission by the power transmission device 10.

After that, in a case where the marker M (the second image) of the mobile terminal 200 is positioned by the user to be aligned with the print image PI (the first image) of the power transmission device 10, and then, the “OK” button in the display screen is selected (tapped), the following operation is executed.

The main control unit 201 of the mobile terminal 200 transmits a signal for requesting the start of the power transmission (that corresponds to a “power transmission start command” of the one embodiment, and hereinafter, will be referred to as a “power transmission request”) to the power transmission device 10 through the near field communication by the LAN communication unit 270. In a case where the power transmission request is received, the power transmission control unit 17 of the power transmission device 10 controls each unit of the power transmission device 10 such that the direct current input from the DC/DC converter 16 is fed to the coil exciting circuit 18. Accordingly, as with a case where the switch 13 described in FIG. 1 or the like is switched to an ON state from an OFF state, a power transmission operation is performed to the mobile terminal 200 from the power transmission device 10, and the secondary battery 25 in the mobile terminal 200 is charged.

After such charging processing is started, the main control unit 201, for example, as illustrated in FIG. 10C, performs processing of switching the screen to a display screen for notifying the user that it is “BEING CHARGED”, instead of displaying the marker M (the reference image) on the display unit 231. Alternatively, the main control unit 201, as illustrated in FIG. 10D, may additionally display a message of “WOULD YOU LIKE TO DISCONTINUE CHARGING?”, the “OK” button, and the “Cancel” button while displaying the marker M (the reference image) on the display unit 231. Note that, a display screen illustrated in FIG. 10D is useful in a case where there is a positional shift between the power transmission device 10 and the mobile terminal 200 during the charging processing, and a timing at which such a screen is displayed, or the like will be described below in the description of the flowchart of FIG. 11.

On the other hand, in a case where the “Cancel” button in the display screen illustrated in FIG. 10B is selected (tapped) or the “OK” button in the display screen illustrated in FIG. 10D is selected (tapped), the main control unit 201 of the mobile terminal 200 transmits a signal for requesting the end of the power transmission (that corresponds to a “power transmission discontinuance command” of the one embodiment, and hereinafter, will be referred to as a “power transmission end request”) to the power transmission device 10 through the near field communication by the LAN communication unit 270.

In a case where such a power transmission end request is received, the power transmission control unit 17 of the power transmission device 10 controls each unit such that the feeding of the direct current to the coil exciting circuit 18 is stopped. In this case, as with a case where the switch 13 described in FIG. 1 or the like is switched to an OFF state from an ON state, the power transmission operation to the mobile terminal 200 from the power transmission device 10 and the charging processing of the secondary battery 25 are stopped or ended.

Next, the processing during a charging operation of the secondary battery 25, the transition of each of the display screens described above in FIG. 10A to FIG. 10D, and the like will be described with reference to the flowchart of FIG. 11.

In step S101, the main control unit 201 of the mobile terminal 200 determines whether or not the “CHARGING” icon in the normal screen (refer to FIG. 10A) is selected (tapped), and in a case where it is determined that the “CHARGING” icon is not selected (step S101, NO), the determination processing is repeated. On the other hand, in a case where it is determined that the “CHARGING” icon is selected (tapped) (step S101, YES), the main control unit 201 proceeds to step S102.

In step S102, the main control unit 201 determines whether or not the secondary battery 25 is in a fully charged state by monitoring the output voltage of the secondary battery 25. Here, in a case where it is determined that the secondary battery 25 is in the fully charged state (step S102, YES), the main control unit 201 determines that the charging processing is not necessary, and returns the screen to the normal screen (refer to FIG. 10A) by performing display to the effect that the secondary battery 25 is in the fully charged state.

On the other hand, in a case where it is determined that the secondary battery 25 is not in the fully charged state (step S102, NO), the main control unit 201 determines that the charging processing is necessary, and proceeds to step S103.

In step S103, the main control unit 201 switches the display image of the manipulation display unit 23 to a screen for displaying the marker M (the second image) illustrated in FIG. 10B, the “OK” button, and the “Cancel” button from the normal display state (FIG. 10A). After that, as described above, a positioning operation of the mobile terminal 200 with respect to the power transmission device 10 is performed by the user, and thus, the center position of the power transmission coil 12 of the power transmission device 10A and the center position of the power reception coil 22 in the mobile terminal 200 are accurately aligned.

Subsequently, in step S104, the main control unit 201 determines whether or not to start the charging operation, on the basis of a selection (tapping) result of each of the buttons displayed on the display unit 231.

Here, in a case where the “OK” button is selected (tapped), the main control unit 201 determines to start the charging operation (step S104, YES), and proceeds to step S105. On the other hand, in a case where the “Cancel” button is selected (tapped), the main control unit 201 determines not to start the charging operation (step S104, NO), switches the display image of the display unit 231 to the normal display (FIG. 10A), and returns the processing to step S101.

In step S105, the main control unit 201 transmits the power transmission request to the power transmission device 10 through the near field communication by the LAN communication unit 270, and waits the power feeding from the power transmission device 10 by monitoring the output voltage of the rectification smoothing unit 24.

In a case where the power transmission request is received through the LAN communication unit 19, the power transmission control unit 17 of the power transmission device 10 excites the power transmission coil 12 by driving the coil exciting circuit 18, and thus, starts the power transmission to the power reception coil 22 in the mobile terminal 200 (the power reception device 20).

After such power transmission is started, in a case where the output voltage of the rectification smoothing unit 24 of the power reception device 20 is greater than or equal to a predetermined threshold value (a voltage value that is sufficient to charge the secondary battery 25, the same applies to the following), the main control unit 201 of the mobile terminal 200 starts the charging operation (the charging processing) of charging the secondary battery 25 (step S106).

Subsequently, in step S107, the main control unit 201 of the mobile terminal 200 switches the display image of the display unit 231 to the screen illustrated in FIG. 10C (that is, the normal screen to which the display of “BEING CHARGED” is added) from the screen illustrated in FIG. 10B, and notifies the user that the secondary battery 25 is currently being charged.

After that, the main control unit 201 determines whether or not the output voltage of the rectification smoothing unit 24 is greater than or equal to the threshold value described above by monitoring the output of the rectification smoothing unit 24 (step S108).

Here, in a case where it is determined that the output voltage of the rectification smoothing unit 24 is greater than or equal to the threshold value (step S108, YES), the main control unit 201 determines that there is no positional shift between the power transmission coil 12 and the power reception coil 22, and proceeds to step S111.

On the other hand, in a case where it is determined that the output voltage of the rectification smoothing unit 24 does not reach the threshold value (step S108, NO), the main control unit 201 determines that the positional relationship between both of the coils (12 and 22) is poor (the mobile terminal 200 deviates from a charging area), and proceeds to step S109.

Note that, as a specific case example in which NO is determined in step S108, various cases can be exemplified, but typically, the specific case example can be broadly divided into the following two types (“Case 1” and “Case 2”).

Case 1, for example, is a case where there is a positional shift between both of the coils 12 and 22 by an external force that is not intended by the user, such as an earthquake. On the other hand, Case 2 is a case in which there is a positional shift between both of the coils 12 and 22 by the intention of the user, such as a case where the user starts a conversation by answering an incoming call to the mobile terminal 200.

In consideration of Case 1 described above, in a case where NO is determined in step S108, the main control unit 201 may control the sound output unit 241 such that an alarm (a warning tone) is sounded. In addition, in consideration of a case where the probability of occurrence of Case 1 is low, the use in the public area, and the like, it may be configured that the on/off, the volume, or the like of the alarm (the warning tone) described above can be set in advance by the user.

In step S109, the main control unit 201 switches the display screen of the display unit 231 to the screen with the marker M (the second image). Further, here, the charging processing is being executed with respect to the secondary battery 25, and in order to check whether or not to continue such charging processing, as illustrated in FIG. 10D, the message (a question) of “WOULD YOU LIKE TO DISCONTINUE CHARGING?”, the “OK” button, and the “Cancel” button are displayed in the screen to be capable of being selected.

By displaying the marker M and the display screen relevant to the availability of charging discontinuance, as illustrated in FIG. 10D, the convenience for the users of both of Case 1 and Case 2 can be attained.

That is, the user of Case 1 is capable of understanding that there are a shift in the marker M with respect to the print image P1 and an unexpected positional shift between both of the coils 12 and 22 at a glance, and is capable of promptly correcting the positional shift in the mobile terminal 200 and of returning a power transmission state and the power feeding efficiency to a normal state by tapping the “Cancel” button.

On the other hand, as necessary, the user of Case 2 in which there is an intentional positional shift, as described below, cancels the display of the unnecessary marker M and returns the screen to the screen of FIG. 10A by tapping the “OK” button in the screen of FIG. 10D, and thus, is capable of promptly using other functions such as a telephone.

In step S110, the main control unit 201 determines whether or not to discontinue the charging. Here, in a case where the “OK” button in the display screen is selected (tapped), the main control unit 201 determines to discontinue the charging (step S110, YES), and proceeds to step S112.

On the other hand, in a case where the “Cancel” button is selected (tapped) or in a case where a predetermined time has elapsed without selecting (tapping) any button, the main control unit 201 determines to perform the charging without discontinuance (step S110, NO), and proceeds to step S111.

Note that, in a case where a predetermined time has elapsed without selecting (tapping) any button, the main control unit 201 determines to discontinue the charging by the presetting or the like of the user (step S110, YES), and proceeds to step S112. In this case, the waste of the power transmission power of the power transmission device 10 is suppressed.

In step S111, the main control unit 201, for example, determines whether or not the secondary battery 25 is in the fully charged state by monitoring the transition of the output voltage of the secondary battery 25. Here, in a case where it is determined that the secondary battery 25 is not yet in the fully charged state (step S111, NO), the main control unit 201 returns to the determination processing of step S108, and repeats each of the processings described above. On the other hand, in a case where it is determined that the secondary battery 25 is in the fully charged state (step S111, YES), the main control unit 201 proceeds to step S112.

In step S112, the main control unit 201 transmits the power transmission end request described above to the power transmission device 10 through the near field communication by the LAN communication unit 270. In a case where such a power transmission end request is received, the power transmission control unit 17 of the power transmission device 10 controls each of the units such that the current feed to the coil exciting circuit 18 is stopped and the excitation of the power transmission coil 12 is stopped.

Accordingly, as with a case where the switch 13 described in FIG. 1 or the like is switched to an OFF state from an ON state, the power transmission operation to the mobile terminal 200 from the power transmission device 10 is stopped, and in accordance with such stop of the power transmission, the main control unit 201 ends the charging operation (the charging processing) of the secondary battery 25 in the mobile terminal 200 (step S113).

Then, the main control unit 201 switches the display screen of the display unit 231 to the normal screen illustrated in FIG. 10A (that is, the initial screen on which the marker M is not displayed) (step S114), and ends a set of processings.

By executing the processing described above, in particular, the processing of step S108 to step S111, for example, even in a case where there is a positional shift between both of the coils 12 and 22 by an unintentional vibration, an external force, or the like, during the charging of the secondary battery 25, the marker M (the second image) is promptly displayed on the display unit 231 such that notification (warning) and operation support with respect to the user are performed.

Therefore, according to the second embodiment, the positional shift that occurs between the power transmission coil 12 and the power reception coil 22 during the power feeding operation is promptly corrected by the user, and thus, the power transmission (the power feeding) efficiency can be ensured.

In addition, in each of the embodiments described above, the marker M (the second image) is displayed only in a period or a scene in which the marker M is necessary (that is, at the time of the charging operation). In other words, according to each of the embodiments, the display of the marker M (the second image) with respect to the display unit 231 is not performed (cancelled) in the normal use not relevant to the charging operation, and thus, it is not necessary for the user to be aware of the position of the power reception coil 22, or the like, at the time of making a call, of inputting a text message, and of using the internet (suitably refer to FIG. 10A or the like), and it is possible for the user to concentrate (focus) on the call or the like.

(Other Display Modes)

In each of the embodiments described above, as the marker M (the reference image or the second image) displayed on the manipulation display unit 23, two straight lines (horizontal and vertical reference lines) orthogonal to each other at the position facing the center of the power reception coil 22, and the black circle are displayed. In addition, as the print image PI (the first image) printed on the upper surface of the housing 11 of the power transmission device 10, as with the marker M (the second image) described above, two straight lines (reference lines) orthogonal to each other at the position facing the center of the power transmission coil 12, and the black circle are printed.

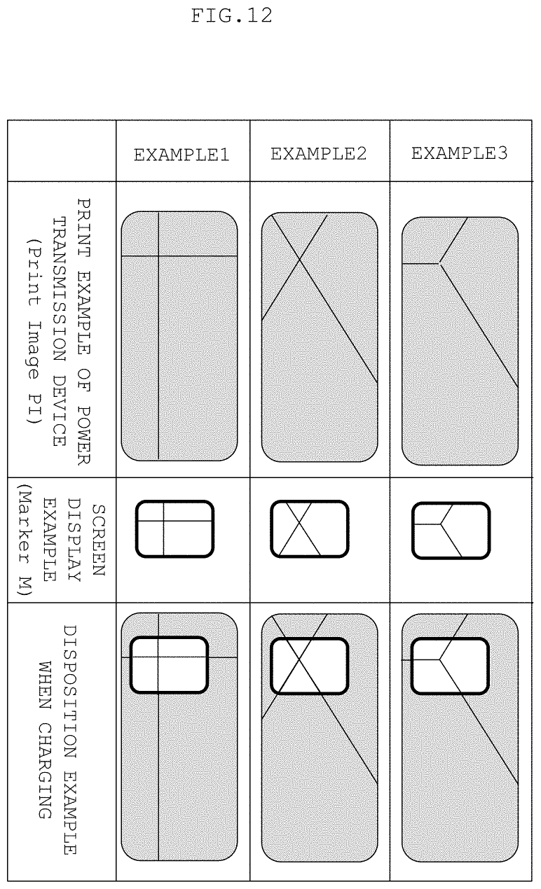

On the other hand, the shape of the marker M and the print image PI (an image to be a reference or an index for positioning) is not limited thereto, and as exemplified in FIG. 12 to FIG. 14, various shapes can be used in which the positioning of both of the coils 12 and 22 can be attained.

FIG. 12 is a reference chart in which specific examples (“Example 1”, “Example 2”, and “Example 3”) in a case of configuring the print image PI (the first image) and the marker M (the second image) with a straight line are collected.

In the embodiments described above, the print image PI and the marker M are based on the shape of “Example 1” in FIG. 12 (Table). As another example, the print image PI (the first image) and the marker M (the second image) may be based on the shape of “Example 2” in FIG. 12 (Table).

Here, as seen in the comparison with the shape of “Example 1”, the shape illustrated in “Example 2” is the same as the shape of “Example 1” in that two straight lines intersect with each other at the position facing the center of each of the coils 12 and 22, but is different from the shape of “Example 1” in that the straight lines do not orthogonally intersect with each other, and the end portions of each of the straight lines extend in directions different from those of “Example 1”.

As another example, the print image PI (the first image) and the marker M (the second image) may be based on the shape of “Example 3” in FIG. 12 (Table).

Here, the shape illustrated in “Example 3” is different from both of the shapes of “Example 1” and “Example 2” in that three straight lines radially extend from the position facing the center of each of the coils 12 and 22, but is similar to the shape of “Example 2” in that two of the three straight lines extend in the same directions as those of “Example 2”.

From another viewpoint, a case where the planar shape (the outer shape or the outline, the same applies to the following) of each of the coils 12 and 22 is a circular shape is also considered in the shape of “Example 1”, and the mobile terminal 200 can be charged in four positions (placement modes) with respect to the upper surface of the power transmission device 10.

In contrast, the shape of “Example 2” is suitable to a case where the planar shape of each of the coils 12 and 22, for example, is an elliptical shape, and the mobile terminal 200 can be charged in two positions (placement modes) with respect to the upper surface of the power transmission device 10.

Further, the shape of “Example 3” is suitable to a case where the planar shape of each of the coils 12 and 22, for example, is a distorted shape, and is premised on a specification in which the mobile terminal 200 can be charged in one position (placement mode) with respect to the upper surface of the power transmission device 10.

Note that, in this example in which the power transmission coil 12 is disposed on the comparatively end side of the power transmission device 10, the mobile terminal 200 is likely to drop or a shift between the coils 12 and 22 is likely to occur. For this reason, it is desirable that the power transmission (charging) processing described above is performed in the actual use, in an installation mode in which the entire mobile terminal 200 is placed on the upper surface of the power transmission device 10.

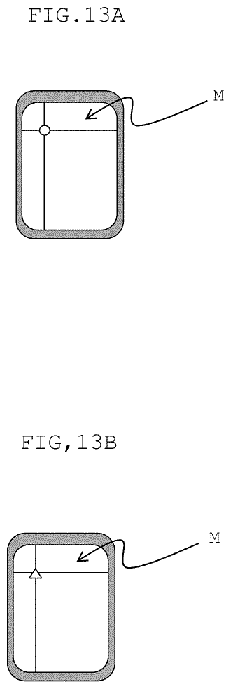

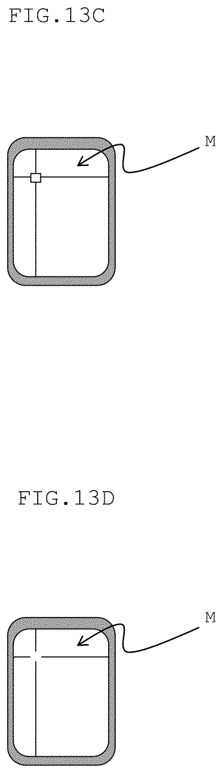

Further, FIG. 13A to FIG. 13D illustrate modification examples of the mark indicating the center position of the power reception coil 22 in the configuration of “Example 1” in FIG. 12 (Table). In the embodiments described above, the mark indicating the center position of the power reception coil 22 is a black circle “●”, but as another example, various shapes such as a circular frame “◯” (refer to FIG. 13A) having any other ground color such as a background color, a triangular frame “Δ” (refer to FIG. 13B), a quadrangular frame “□” (refer to FIG. 13C), and a background color region without a frame (refer to FIG. 13D) can be used.

The same applies to modification examples of the configuration of the print image PI (the first image), that is, the mark indicating the center position of the power transmission coil 12.

From another viewpoint, each of the print image PI (the first image) and the marker M (the second image) includes a line proceeding to the position facing the center of the power transmission coil 12 and the power reception coil 22. In this case, a line configuring an image in a relatively small device (in this example, the marker M of the mobile terminal 200) extends to the lateral end side of the device, and a line configuring an image in a large device (in this example, the print image PI of the power transmission device 10) extends to a position protruding from the lateral end of the small device at the time of positioning.

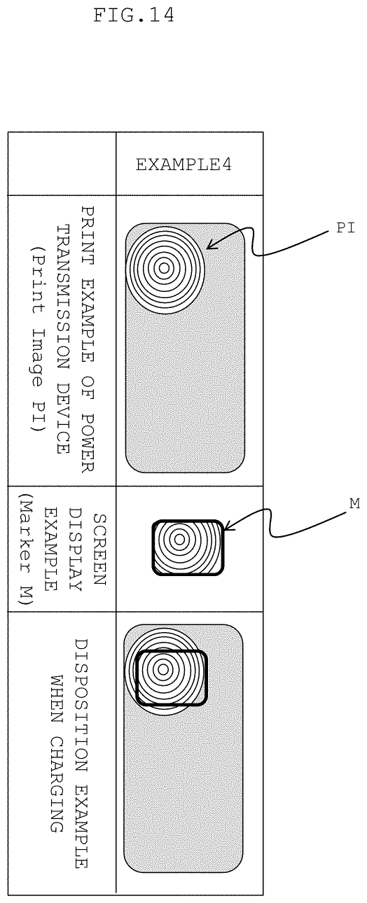

Further, FIG. 14 is a table showing one specific example (Example 4) in a case where each of the coils 12 and 22 are in the shape of a planar circle and the print image PI (the first image) and the marker M (the second image) are configured with a curved line.

A case in which the upper surface of the power transmission device 10 is sufficiently larger than the mobile terminal 200, and arbitrary properties are provided in the installation mode in which the entire mobile terminal 200 is placed on the upper surface of the power transmission device 10 is also considered in the shape illustrated in “Example 4”, unlike Example 1 to Example 3 described above. That is, the print image PI and the marker M illustrated in “Example 4” of FIG. 14 are in the shape of multiple circles concentrically extending from the position facing the center point of each of the coils 12 and 22, and for this reason, the degree of freedom of the installation mode of the power transmission device 10 with respect to the power transmission device 10 is high.

Various examples described above can be suitably combined or arbitrarily modified.

For example, as a modification example of “Example 3” of FIG. 12, three lines (not limited to straight lines) extending in three directions from the center position of each of the coils 12 and 22 at an angle of 60° to each other may be displayed.

In addition, in the embodiments and the modification examples described above, the mark (the black circle or the like) indicating the center position of the power reception coil 22 and the mark (the black circle or the like) indicating the center position of the power transmission coil 12 are in the same size, but the size is not limited thereto, and a magnitude relationship may be provided.

As an example, a magnitude relationship can be provided in the mark (for example, the black circle) of each of the center positions such that an error or an allowable range of a positional shift between both of the coils 12 and 22 is represented. In other words, in a case where the position of one small black circle is in the other large black circle, sufficient power may be fed.

As an alternative or additional example, the display unit is provided in the power transmission device 10, that is, the device on the power feeding side or there is the existing display unit, a reference index (a mark corresponding to the print image PI described above) indicating the center position of the power transmission coil 12 may be displayed on such a display unit. Such a configuration can be suitably applied to a case in which the power transmission device 10 is comparatively small, or a system in which the power feeding (the charging) is performed by placing the power transmission device 10 on the power reception device 20, on the contrary to the configuration example described above. In addition, in a case where there is the existing display unit, accurate positioning of the coils 12 and 22 and the ensuring of the power feeding efficiency can be attained at a low cost by effectively utilizing the display unit.

Generally, in the embodiments of the one embodiment, when both of the coils 12 and 22 are positioned between the power transmission device 10 including the power transmission coil and the power reception device 20 including the power reception coil 22, the reference image is displayed on the display unit of at least one device to be positioned with the reference image of the other device, and thus, sufficient power can fed to the power reception device 20 from the power transmission device 10.

As described above, in a case where the first image and the second image that are represented on each of the devices are positioned, the center points of both of the coils 12 and 22 are coincident with each other, and thus, even in a case where the outer diameters or the like of both of the coils 12 and 22 are slightly different from each other, the power transmission efficiency can be ensured.

Each of the embodiments described above is premised on the fact that the power transmission coil 12 and the power reception coil 22 to be used are mainly in the shape of a planar circle or an ellipse, in other words, a case in which the length and the breadth in a 2-dimensional coordinate are symmetric and the center point of the coil is in a distinct planar shape.

In contrast, in the power transmission coil and the power reception coil, for example, a coil having a more arbitrary planar shape, in other words, having a planar shape in which the length and the breadth described above are asymmetric and the center point is less likely to be specified can also be adopted due to a limitation (a space, an influence on the other element, and the like) on the disposition of the device on the power reception side.

Therefore, the marker M that is displayed on the display unit is not limited to the display mode in which the center positions of both of the coils are coincident with each other, but may be a display mode in which the outer shapes (the outlines) of both of the coils are capable of being coincident with each other or of corresponding to each other.

In addition, each of the embodiments has been described on the premise of the fact that the upper surface of the housing 11 of the power transmission device 10 (the placement surface of the mobile terminal 200) is a horizontal surface (a non-inclined surface), but such an upper surface may be an inclined surface. Specifically, from the viewpoint of versatility, that is, performing the power transmission (the charging or the like) with respect to various power reception devices, it is considered that a configuration of placing the power reception device on the horizontal surface as described above is desirable.

On the other hand, in a charger that is generally referred to as a station or a cradle, the type of power reception device that is a charging target is often limited. In addition, for example, a leaning type power transmission and reception system of positioning the power reception device placed on the inclined surface of the cradle by a slide movement in a horizontal direction can also be used. In such a case, it is only necessary to pay attention to a positional shift in the horizontal direction, and thus, the print image PI (the first image) and the marker M (the second image) described above can be more simply configured.

In the embodiments described above, a configuration has been described in which an area ratio of the display unit 231 that is disposed on the frontal surface (the front surface) of the housing 21 of the mobile terminal 200 is large, and the power reception coil 22 falls within the screen of the display unit 231, but the one embodiment is not limited thereto.

Specifically, even in a configuration in which the area ratio of the display unit 231 with respect to the housing 21 is small, and a configuration in which the power reception coil 22 does not fall within the screen of the unit 231, the marker M (the second image) for attaining the positioning of both of the coils (12 and 22) can be displayed on the display unit 231 by disposing a plurality of hardware buttons on the surface of the housing 21.

As one non-restrictive specific example of such a case, for example, a cross line (the first image) indicating the center of the display unit on the power reception device side (having a small area) may be provided on the housing 11 of the power transmission device 10, the marker M (the second image) corresponding to such a cross line may be displayed on the display unit on the power reception device side, and the centers of both of the coils (12 and 22) are positioned in a case of positioning the first image and the second image.

In addition, the embodiments have been described on the premise of a configuration using an electromagnetic guidance type power feeding system with strict positioning standards, as the wireless power feeding system, but the one embodiment can also be applied to other systems, for example, a magnetic field resonance type system with relatively loose positioning standards.

As one non-restrictive specific example of such a case, in a configuration in which the power transmission unit (the coil or the like) is provided approximately in the center of the power transmission device including the housing of which the area of the upper surface is comparatively large, a curved line (a circle) for partitioning the charging area is provided on the upper surface around the power transmission unit, as the print image PI (the first image). On the other hand, the display unit 231 of the mobile terminal 200 displays a curved line (a circular arc) corresponding to the circle of the print image PI (the first image), as the marker M (the second image), under the control of the main control unit 201. According to such a configuration, the user is capable of performing the power transmission (the charging) by placing more mobile terminals 200 in the vicinity of the boundary of the charging area.

Generally, the marker M that is displayed on the display unit 231 may be a still image that is fixedly displayed in the display screen and may have a configuration (shape or a display mode) in which a sufficient power transmission efficiency can be obtained in a case of being positioned with the first image on the other side (in the example described above, the power transmission device side).

Accordingly, the characteristic configuration described above can be applied to an arbitrary type of wireless power transmission and reception system in which there is a problem such as a decrease in the power feeding efficiency due to the positional shift.

In addition, the characteristic configuration described above may be applied to an arbitrary type of wired power transmission and reception system in which there can be a decrease in the power transmission (the power feeding) efficiency due to a positional shift between contact terminals.

For example, the characteristic configuration described above can also be applied to a case in which in a configuration in which the charging or the like is performed by bringing the terminals into contact each other when the power reception device is leaned against the charger described above (the power transmission device) that can be referred to as a station or a cradle, it is difficult to observe the position of the terminal, and thus, a positional shift is likely to occur at the time connection.

In addition, the communication between the power transmission device 10 and the mobile terminal 200 may be performed by using a coil for power transmission instead of the LAN communication units 19 and 270 described above in FIG. 9.

The embodiments and the modification examples described above are merely a specific example for implementing the one embodiment, and the technical scope of the one embodiment is not limitedly construed by the embodiments and the modification examples. That is, the one embodiment can be implemented in various forms without departing from the gist or the main characteristics thereof.

What is claimed is:

1. A power transmission and reception system, comprising:
a first device including an outer surface on which a first image is represented; and
a second device including an outer surface on which a second image is represented, the second device being placed on the first device,
wherein one of the first device and the second device is a power transmission device including a power transmission unit,
the other of the first device and the second device is a power reception device including a power reception unit, and
when the power transmission device and the power reception device are positioned such that the first image and the second image are aligned, power is capable of being fed such that a received voltage is greater than or equal to a predetermined value at the time of transmitting power to the power reception unit from the power transmission unit.

2. The power transmission and reception system according to claim 1,
wherein the second device includes a display unit displaying a still image having a shape corresponding to the first image as the second image.

3. The power transmission and reception system according to claim 2,
wherein the power transmission unit is a power transmission coil in the power transmission device, and
the power reception unit is a power reception coil in the power reception device.

4. The power transmission and reception system according to claim 3,
wherein the first image and the second image are positioned such that a center of the power transmission coil and a center of the power reception coil are positioned.

5. The power transmission and reception system according to claim 4,
wherein each of the first image and the second image includes a line proceeding to a position facing the center of the power transmission coil and the power reception coil, and
the line of a small device among the power transmission device and the power reception device extends to a lateral end side of the small device, and the line of a large device among the power transmission device and the power reception device extends to protrude from the lateral end of the small device at the time of positioning.

6. The power transmission and reception system according to claim 5,
wherein each of the first image and the second image includes two or more lines intersecting with each other at the position facing the center of the power transmission coil and the power reception coil.

7. The power transmission and reception system according to claim 6,
wherein each of the first image and the second image includes ring-shaped lines radially arranged from the position facing the center of the power transmission coil and the power reception coil.

8. The power transmission and reception system according to claim 2,
wherein the display unit displays the second image, in accordance with an instruction of a user.

9. The power transmission and reception system according to claim 2, further comprising:
a display control unit controlling display and non-display of the second image on the display unit.

10. A power reception device, comprising:
a power reception unit capable of being close to a power transmission unit of a power transmission device; and
a display unit displaying a second image corresponding to a first image that is represented on the power transmission device,
wherein when the first image and the second image are positioned, power is capable of being received such that a received voltage is greater than or equal to a predetermined value at the time of transmitting power to the power reception unit from the power transmission unit.

11. The power reception device according to claim 10,
wherein the power reception unit is a power reception coil capable of facing a power transmission coil of the power transmission unit, and
the second image is a still image that is an index of a position of the power reception coil.

12. The power reception device according to claim 11,
wherein the second image includes a line having a shape passing through or surrounding a position facing a center of the power reception coil, and
the display unit displays the line of the second image to extend to an end side of a display region.

13. The power reception device according to claim 10, further comprising:
a power transmission operation switching unit outputting a power transmission start command and a power transmission discontinuance command to the power transmission device to switch on/off of power transmission by the power transmission device.

14. The power reception device according to claim 13,
wherein the display unit cancels display of the second image when the power transmission discontinuance command is output.

15. A power transmission device, comprising:
a housing on which a first image corresponding to a second image that is displayed on a power reception device is represented; and
a power transmission unit capable of being close to a power reception unit of the power reception device, the power transmission unit being contained in the housing,
wherein when the first image and the second image are positioned, the first image is represented at a position of the housing at which a received voltage in the power reception unit is greater than or equal to a predetermined value.
